(19) United States
(12) Patent Application Publication
(10) Pub. No.: US 2016/0075197 A1
(43) Pub. Date: Mar. 17, 2016

(54) COUPLING SYSTEM

(71) Applicant: SASPER PTY LTD, Caulfield North, Victoria (AU)

(72) Inventors: Marcus Coleman, St. Kilda (AU); Alexey Olshevskii, Bryansk (RU); Alexander Olshevskiy, Bryansk (RU)

(21) Appl. No.: 14/784,889

(22) PCT Filed: Apr. 17, 2014
(86) PCT No.: PCT/AU2014/000452

§ 371 Date: Oct. 15, 2015

(30) Foreign Application Priority Data
Apr. 19, 2013 (AU) 2013901382

(51) Int. Cl. B60D 1/04; B60D 1/145; B60D 1/48; B62D 53/08

(52) U.S. Cl. CPC B60D 1/04; B62D 53/0864; B60D 1/145; B60D 1/488

(57) ABSTRACT

A roll coupling system (208) for linking a tow vehicle (4) and a drawn vehicle (6), the system (208) comprising:
a roll coupling device (2) comprising,
   a roll coupling member (10) for coupling with a draw member (12), the roll coupling member (10) having upwardly and downwardly facing coupling surfaces (14, 238) adapted for slidable engagement therewith;
   a locking mechanism (20) for locking the roll coupling member (10) in connection with the draw member (12); and
   a support mechanism (16) for mounting the roll coupling member (10) on a tow member (18) of the tow vehicle (4); and
the draw member (12) comprising,
   a wrap-around skid assembly (228) adapted to wrap over, around a side of, and under a portion of the roll coupling member (10), thereby slidably engaging the upwardly and downwardly facing coupling surfaces (14, 328) of the roll coupling member (10).

### TECHNICAL FIELD

The present invention relates to apparatus for linking vehicles. In a particular aspect, the invention may relate to a fifth wheel device mountable on the rear overhang of a tow vehicle. In another particular aspect, the invention may relate to a drawbar structure improved for torsion or weight.

### BACKGROUND ART

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and broad consistory statements herein.

Fifth wheel devices, such as that referenced by numeral 206 in FIGS. 18 and 19, have been used to roll couple prime movers 138 with semitrailers 8. A typical fifth wheel device 206 is approximately 900 mm wide by 800 mm deep. Given the substantial size and weight of the typical fifth wheel device 206, it is required to be supported atop the strong horizontal chassis beams of the prime mover.

Pin couplings and ball couplings are other types of coupling devices which can be attached to the rear overhang of a prime mover rather than atop the horizontal beams of the chassis. However, whilst pin couplings and ball couplings are able to join the prime mover with the semitrailer, they do not provide a roll coupling for transferring roll motion between the two vehicles.

A drawbar is another type of coupling device used for linking vehicles. A typical drawbar comprises an A-frame constructed of square-shaped beams. However, such drawbars may not be optimised for torsion or weight as may be required where significant loads or stresses are involved, such as in the roll coupling of two large trailers.

Thus, it may be advantageous to provide a coupling apparatus, which reduces, limits, overcomes, or ameliorates some of the problems, drawbacks, limitations or disadvantages associated with prior art devices, or provides an effective alternative to such devices.

For instance, it may be advantageous to provide a new smaller and lighter fifth wheel device. Further, it may be advantageous to provide a new roll coupling device which is able to be fixed to the rear overhang of a tow vehicle.

It may also be advantageous to provide a new draw member or drawbar with optimised torsion or weight characteristics. Such an improved drawbar may allow more freedom of choice in roll coupling devices to be used in conjunction therewith.

### DISCLOSURE OF THE INVENTION

In one aspect the invention may provide a roll coupling device for linking a tow vehicle and a drawn vehicle, the device comprising:
a roll coupling member connectable to a draw member, the roll coupling member having a coupling surface adapted for slidable rotation of the draw member thereon, the draw member being attachable to or formed with the drawn vehicle; and
a support mechanism for supporting the roll coupling member on a tow member, the support mechanism being adapted for attachment to the tow member, the tow member being attachable to or formed with the tow vehicle.

The term drawn vehicle refers to a vehicle intended to be, or being, drawn.

In another aspect, the invention may provide a roll coupling device for linking a tow vehicle and a drawn vehicle, the device comprising:
a roll coupling member for coupling with a wrap-around skid assembly of a draw member, the draw member being directly or indirectly connectable to or formed with the drawn vehicle, the roll coupling member having upwardly and downwardly facing coupling surfaces adapted for slidable engagement with the wrap-around skid assembly;
a locking mechanism for locking the roll coupling member in connection with the draw member; and
a support mechanism for mounting the roll coupling member on a tow member attachable to or formed with the tow vehicle.

The support mechanism may be adapted for attachment to a rearward or downward facing surface of the tow member.

The support member or roll coupling member may not be required to rest atop the tow member. The support member or roll coupling member may not be required to rest atop a generally horizontal member of the tow vehicle. The support member or roll coupling member may not be required to rest atop the chassis of the vehicle, or atop a further member mounted atop the chassis.

The support mechanism may be adapted for attachment to a generally upright surface or plate of the tow member. More particularly, the support mechanism may be adapted for attachment to a substantially upright surface or plate of the tow member.

The support member may be adapted for attachment to a generally vertical surface or plate of the tow member. More particularly, the support member may be adapted for attachment to a substantially vertical surface or plate of the tow member.

The support member may be attached or attachable to a tow member fixed beneath the chassis of the tow vehicle. The tow member may be fixedly hanging from the chassis of the tow vehicle. Thus, the tow member may be attached to or form part of the rear overhang of the tow vehicle.

The support mechanism may be pivotally attached to the roll coupling member so as to enable pitching movement of the draw member.

The roll coupling device may comprise a locking mechanism for locking the drawbar in connection with the roll coupling member.

The coupling member may comprise a fifth wheel.

The coupling member may define a pin hole. The locking member may comprise guide portions for guiding a pin into the pin hole. The pin may be a king pin.

The support mechanism may comprise a support arm member. The support arm member may be adapted for attachment to the tow member. The support arm member may interconnect the coupling member and the tow member. Thus, the support arm member may support the coupling member by virtue of its attachment to the tow member.

The support arm member may be attached to the coupling member. It may be a pivotal attachment enabling upward and downward rotation of the coupling member with respect to the support arm member.

There may be a central support arm member. This may branch into two prongs.

There may be more than one support arm member. In a suitable form, for instance, there may be two support arm members. There may be a pair of lateral support arm members.

The locking mechanism may comprise an enclosing member adapted to enclose the pin within the pin hole. The enclosing member may be adapted to swivel around and enclose the pin as it is moved into the pin hole. The locking mechanism may be adapted for locking the enclosing member when the pin is enclosed in the pin hole.

The draw member may comprise a beam member. The beam member may comprise a generally upright web interconnecting a pair of generally horizontal flanges at top and bottom of the web. Thus, the beam member may be C-shaped or I-shaped, or box-shaped where a pair of parallel upright webs is present. The beam member may be rectangularly box shaped. There may be multiple beam members.

The draw member may comprise a rear beam member, and a pair of converging beam members extending forwards and converging towards each other from proximate opposite ends of the rear beam member. Thus, the draw member may comprise a generally triangular shaped portion when viewed from above.

The draw member may further comprise a pair of front beam members extending forward from proximate the front ends of the converging beam members. The front beam members may be substantially parallel. Each beam member may be of one of the forms mentioned above.

The draw member may comprise a skid plate. The skid plate may be adapted for sliding on or with respect to the coupling surface of the roll coupling member. The skid plate may be attached to or formed with the bottom flanges of the front beam members.

The draw member may further comprise generally horizontal gussets extending between the converging beam members, or between the front beam members. The gussets may be attached to or formed with the top or bottom flanges of the beam members. Thus, the portion of the draw member in front of the converging beam members may be box-shaped. It may be rectangularly box-shaped when viewed from above.

The draw member may comprise a pin for rotatable connection to the coupling member. It may be attached to the underside of the skid plate. The pin may comprise a king pin.

The tow member may be fixedly hanging from the chassis of the tow vehicle. It may comprise an attachment plate for attachment of the roll coupling device. The tow member may comprise a generally upright surface suitable for attachment of the roll coupling device.

The tow vehicle may comprise an engine driven vehicle. It may comprise a prime mover, truck, tractor or car. The tow vehicle may comprise a trailer.

The drawn vehicle may comprise a trailer. It may comprise a semi-trailer, pig trailer (centre axle trailer), dog trailer, or dolly. The drawn vehicle may comprise an engine driven vehicle.

The roll coupling device may comprise the draw member.

The roll coupling device may comprise the tow member.

In another aspect, the invention may provide a method of mounting a roll coupling device on a tow vehicle in such a manner that the roll coupling device is not required to be rested atop the chassis of the tow vehicle.

In another aspect, the invention may provide a method of attaching a roll coupling device to a tow vehicle, the roll coupling device comprising a fifth wheel and a support member for supporting the fifth wheel on the tow vehicle, the method comprising: attaching the support member of the roll coupling device to a plate fixedly hanging from the chassis of the tow vehicle.

In another aspect, the invention may provide a roll coupling system for linking a tow vehicle and a drawn vehicle, the system comprising:
a tow member hanging or adapted to be hung from the chassis of the tow vehicle towards the rear end thereof, the tow member comprising an upright surface or upright plate;
a roll coupling device comprising,
   a roll coupling member connectable to a draw member, the roll coupling member having upwardly and downwardly facing coupling surfaces adapted for slidable engagement therewith;
   a locking mechanism for locking the roll coupling member in connection with the draw member; and
   a support mechanism for supporting the roll coupling member on the tow member, the support mechanism being adapted for attachment to the upright surface or upright plate of the tow member; and
the draw member comprising,
   a frame, towards the rear end of which is a connection or adaption for connection with the drawn vehicle,
   a wrap-around skid plate assembly towards the front end of the frame, the wrap-around skid plate assembly comprising,
      a skid plate adapted for sliding on the upwardly facing coupling surface of the roll coupling member, and
      a wrap-around portion extending downwardly from the skid plate and wrapping around beneath the downwardly facing coupling surface of the roll coupling member, the wrap-around portion being adapted for sliding against the downwardly facing coupling surface.

The locking mechanism may comprise a pneumatic actuator for causing or maintaining locking of the roll coupling member in connection with the draw member, the pneumatic actuator being linked by air line to a park brake of the tow vehicle so that unlocking can only occur when the park brake is engaged.

In another aspect, the invention may provide a draw member for interconnecting a fifth wheel and a drawn vehicle, the draw member comprising:
a frame, towards the rear end of which is an adaption for connection with the drawn vehicle,
a wrap-around skid plate assembly towards the front end of the frame, the wrap-around skid plate assembly comprising,
   a skid plate for sliding upon an upwardly facing coupling surface of a fifth wheel, and
   a wrap-around portion extending downwardly from the skid plate and wrapping around beneath a downwardly facing coupling surface of the fifth wheel, the wrap around portion being adapted to slide against the downwardly facing coupling surface.

The wrap-around portion may comprise:
a pair of side walls extending downwardly from the sides of the skid plate, and
a pair of internal flanges extending inwardly from respective side walls, the internal flanges each having an upwardly facing coupling surface for sliding against and engagement with the downwardly facing coupling surface of the fifth wheel.

In another aspect, the invention may provide a tow member comprising:
an upright plate member comprising,
   an aperture for fitted passage of a support arm of a roll coupling device,
   fastening means for fastening a flange of the support arm once the support arm is fitted in the passage,
   one or more transverse roll stiffeners for strengthening the site of fastening with the flange of the support arm; and
attachment means for attachment of the upright plate to the rear chassis of a tow vehicle so as to form the rear overhang of the tow vehicle.

In another aspect, the invention may provide a method of roll coupling a tow vehicle with a draw bar, the method comprising the steps of:
hanging an upright plate from the rear chassis of the tow vehicle, and
securing a support arm of a fifth wheel to the upright plate, the fifth wheel being adapted for coupling with the draw bar.

In another aspect, the invention may provide a draw member for interconnecting a fifth wheel and a drawn vehicle, the draw member comprising a wrap-around skid assembly adapted to wrap over, around a side of, and under a portion of the fifth wheel, thereby slidably engaging upwardly and downwardly or outwardly facing coupling surfaces of the fifth wheel.

The wrap-around skid assembly may comprise:
a skid plate for sliding upon the upwardly facing coupling surface of the fifth wheel;
a pair of side walls extending downwardly from near the sides of the skid plate; and
a pair of internal flanges extending inwardly from respective side walls, the internal flanges each having an upwardly facing coupling surface for slidable engagement with the downwardly facing coupling surface of the fifth wheel.

In another aspect, the invention may provide a tow member for interconnecting a fifth wheel and a tow vehicle, the tow member comprising:
an upright plate member comprising,
   an aperture for fitted passage of a support arm of a roll coupling device,
   fastening means for fastening a flange of the support arm once the support arm is fitted in the passage,
   one or more transverse roll stiffeners for strengthening the site of fastening with the flange of the support arm; and
attachment means for attachment of the upright plate to the rear chassis of a tow vehicle.

In another aspect, the invention may provide a roll coupling system for linking a tow vehicle and a drawn vehicle, the system comprising:
a roll coupling device comprising,
   a roll coupling member for coupling with a draw member, the roll coupling member having upwardly and downwardly or outwardly facing coupling surfaces adapted for slidable engagement therewith;
   a locking mechanism for locking the roll coupling member in connection with the draw member; and
   a support mechanism for mounting the roll coupling member on a tow member of the tow vehicle; and
the draw member comprising,
   a wrap-around skid assembly adapted to wrap over, around a side of, and under a portion of the roll coupling member, thereby slidably engaging the upwardly and downwardly facing coupling surfaces of the roll coupling member.

### BRIEF DESCRIPTION OF THE DRAWINGS

In order that the invention may be more clearly understood and put into practical effect there shall now be described in detail preferred embodiments in accordance with the invention. The ensuing description is given by way of non-limitative examples only and is with reference to the accompanying drawings, wherein:

FIG. 1 is a top perspective view of a single arm roll coupling device in accordance with the invention;

FIG. 2 is a bottom perspective view of the single arm roll coupling device;

FIG. 3 is an exploded view of the single arm roll coupling device;

FIG. 4 is an exploded view of the single arm roll coupling device with fifth wheel removed;

FIG. 5 is a bottom view of the single arm roll coupling device showing its attachment to a hanging plate of a tow vehicle;

FIG. 6 is a top perspective view of a dual arm roll coupling device in accordance with the invention;

FIG. 7 is a bottom perspective view of the dual arm roll coupling device;

FIG. 8 is a top perspective view of the fifth wheel of the dual arm roll coupling device;

FIG. 9 is a top perspective view of the support mechanism of the dual arm roll coupling device;

FIG. 10 is a bottom view of the dual arm roll coupling device showing its attachment to a hanging plate of a tow vehicle;

FIGS. 11A-F show a sequence of locking and unlocking of the roll coupling device;

FIG. 12 is a top perspective view of the single arm device attached to a towbar and coupled with a drawbar;

FIG. 13 is a bottom perspective view of the single arm device attached to the towbar and coupled with the drawbar;

FIG. 14 is a top perspective view of the dual arm device attached to a towbar and coupled with a drawbar;

FIG. 15 is a bottom perspective view of the dual arm device attached to the towbar and coupled with the drawbar;

FIG. 16 is a side view of the dual arm device attached to the towbar and coupled with the drawbar;

FIG. 17 is a side view of the single arm device attached to the towbar and coupled with the drawbar;

FIG. 18. is a side view illustrating use of a dual arm device in roll coupling a prime mover with a semitrailer, as well as two semitrailers;

FIG. 19 is a side view illustrating use of a single arm device in roll coupling a truck with a dolly;

FIG. 20 is a side view illustrating use of a single arm device in roll coupling a truck with a trailer, as well as a trailer with a trailer;

FIG. 21 is an above perspective view of an improved roll coupling system;

FIG. 22 is a perspective view of a fifth wheel of the improved system attached to the rear overhang of a vehicle;

FIG. 23 is a below perspective view of an improved fifth wheel of the improved system attached to the rear overhang of the vehicle, with the support arm shown in X-ray;

FIGS. 24 and 25 are a sequence of top views respective showing a wearing ring on the improved fifth wheel before and after wearing;

FIG. 26 is an above front perspective view of a first improved support arm of the improved system;

FIG. 27 is a below rear perspective view of a second improved support arm;

FIG. 28 is a side sectional view of the second improved support arm;

FIG. 29 is an above perspective view of a third improved support arm of the improved system;

FIG. 30 is a perspective bottom view of the third improved support arm;

FIG. 31 is a side sectional view of the third improved support arm;

FIG. 32 to an above perspective view of a fourth improved support arm adapted for attachment to a horizontal undersurface;

FIG. 33 is a side sectional view of the third improved support arm attached to a horizontal undersurface;

FIG. 34 is a rear perspective view of an improved tow member of the improved system;

FIG. 35 is a front perspective view of the improved tow member;

FIG. 36 is an underneath perspective view of an improved draw bar of the improved system;

FIG. 37 is an underneath perspective view of a wrap-around skid plate assembly of the improved draw bar;

FIG. 38 is a bottom view of the improved roll coupling system;

FIG. 39 is an underneath perspective view of the improved fifth wheel engaged within the wrap-around skid plate assembly; and

FIGS. 40 to 43 form a sequence of bottom views of an improved locking mechanism of the improved system, which views illustrate enclosure of a king pin within a pin slot by a lock jaw, and engagement and disengagement of primary and secondary locking mechanisms.

### MODES FOR CARRYING OUT THE INVENTION

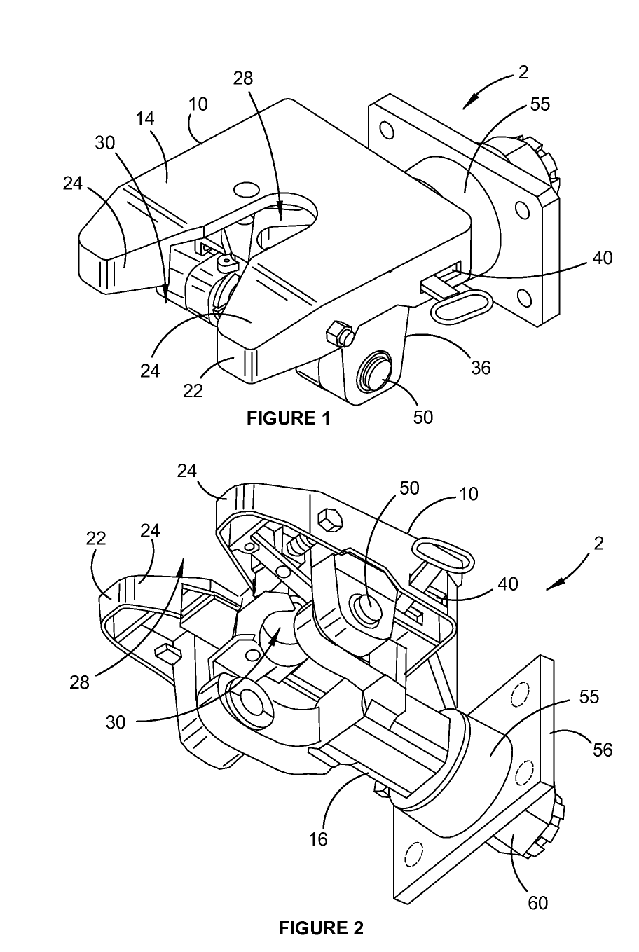

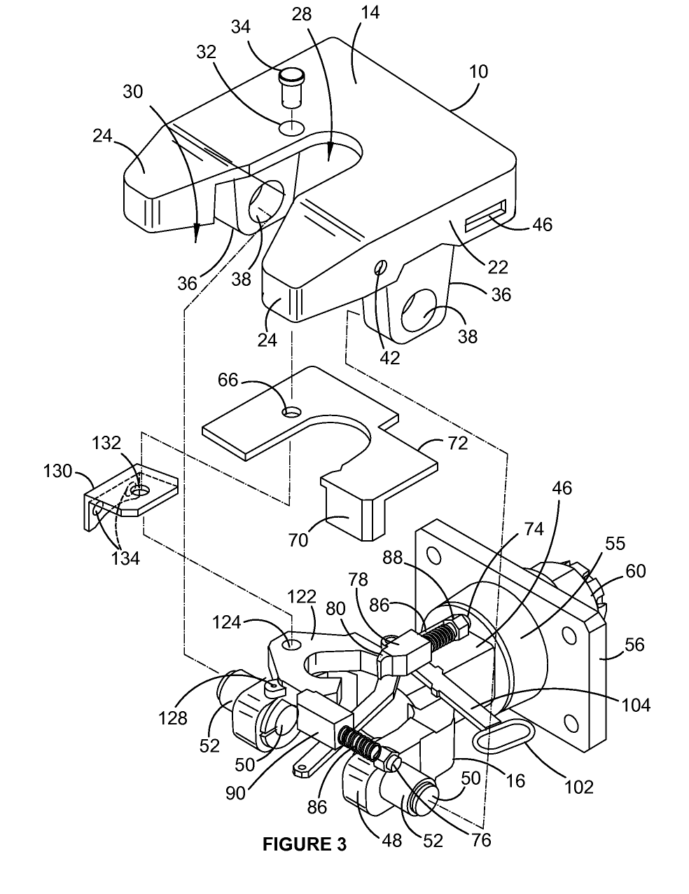

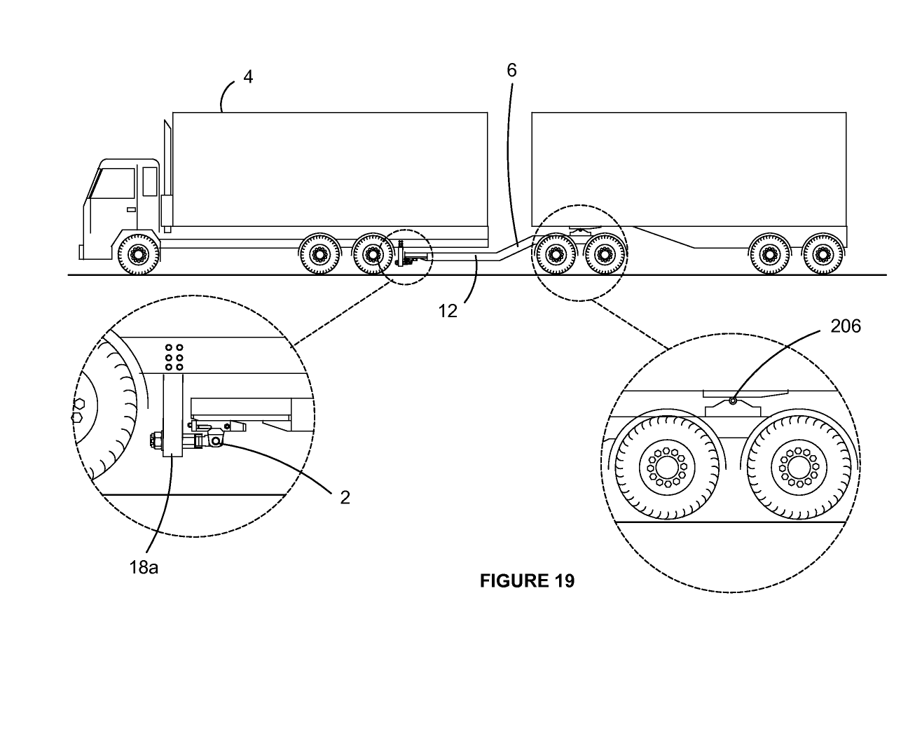

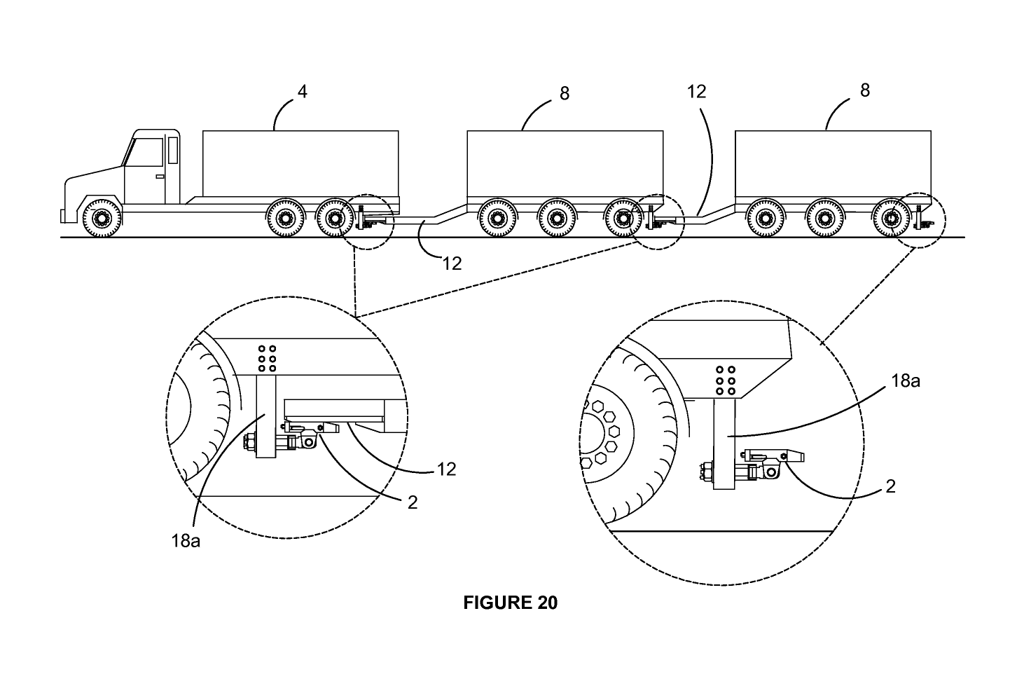

Referring to FIGS. 1 to 5 there is shown a first roll coupling device, generally designated 2, for linking a tow vehicle (see, for example, truck 4 in FIGS. 19 and 20) and a drawn vehicle (see, for example, dolly 6 in FIG. 19, and trailer 8 in FIG. 20).

The first roll coupling device 2 comprises:
a roll coupling member 10 connectable to a draw member 12 (see, for example, FIGS. 19 and 20), the roll coupling member 10 having a coupling surface 14 adapted for slidable rotation of the draw member 12 thereon, the draw member 12 being attachable to the drawn vehicle (6 or 8, for instance);
a support mechanism 16 for supporting the roll coupling member on the tow vehicle, the support mechanism 16 being attachable to a tow member 18 (see, for example, FIGS. 19 and 20), the tow member 18 being fixed to, or as part of, the tow vehicle 4; and
a locking mechanism 20 for locking the draw member 12 in connection with the roll coupling member 10.

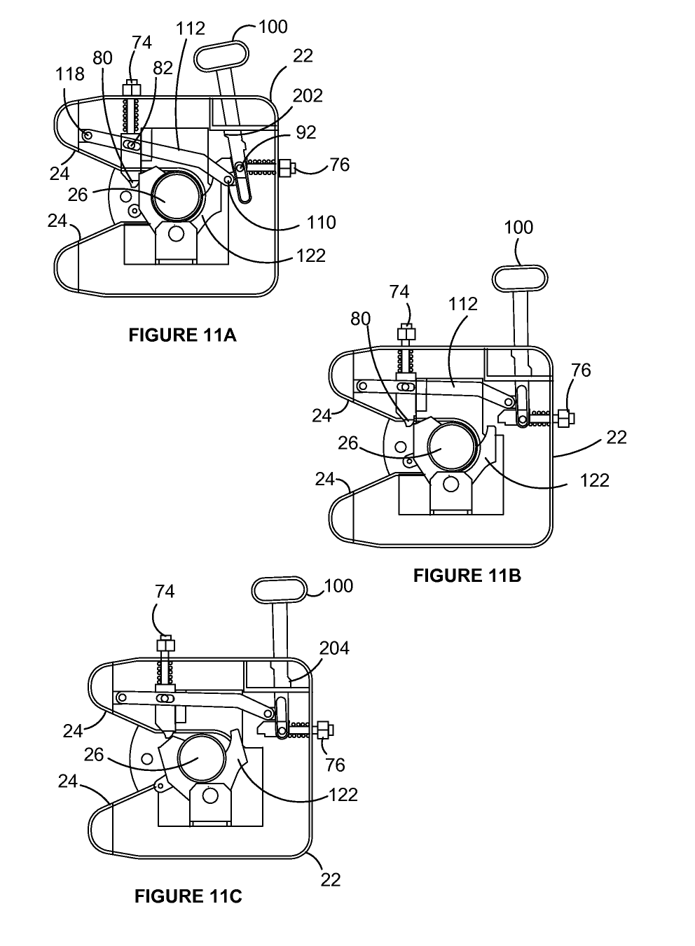

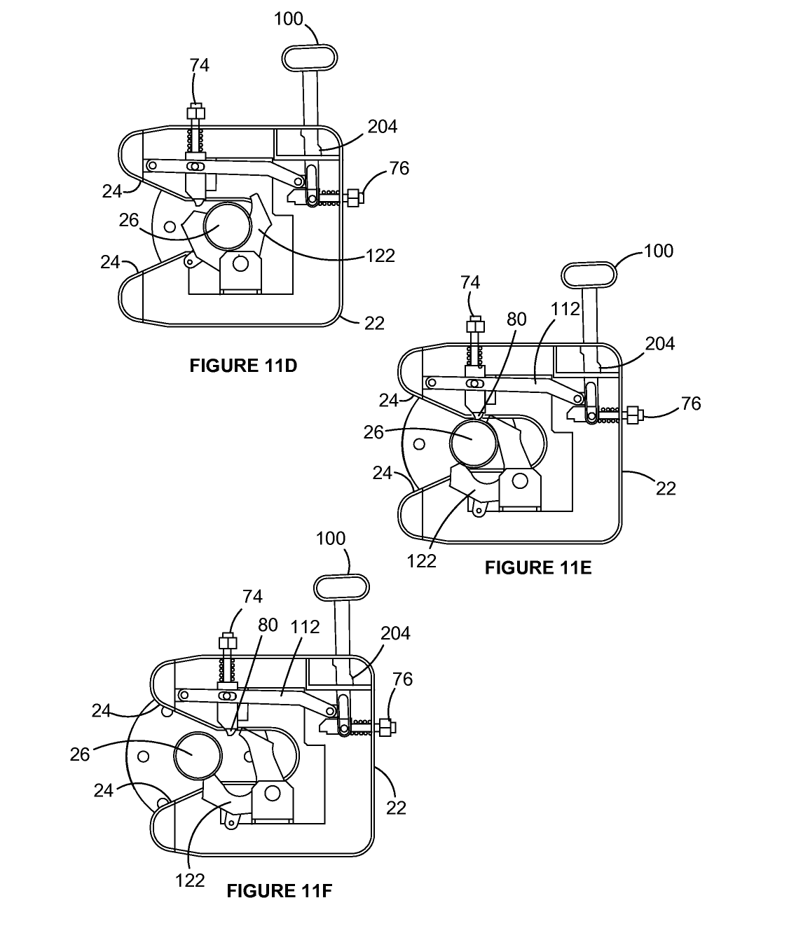

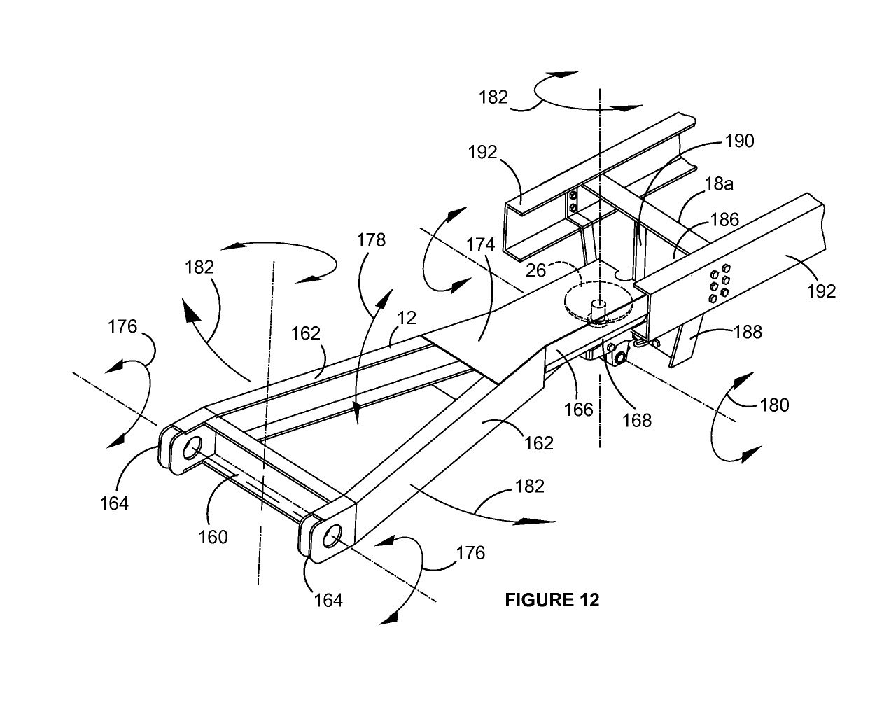

The roll coupling member 10 of the first roll coupling device 2 comprises a coupling plate or fifth wheel 22, the top surface of which is greased or forms a low friction surface 14 such as an ultra-high-molecular-weight polyethylene (UHMWPE, UHMW). Centrally the fifth wheel 22 defines a king pin slot 28 for receipt of a king pin 26 (see FIGS. 11A to F), the king pin 26 being attached to or with the draw member 12 (see FIG. 12, for example).

The king pin slot 28 opens posteriorly into a guide slot 30 which diverges posteriorly to the rear of the fifth wheel 22 and is suitable for guiding the king pin 26 into the pin slot 28. The guide slot 30 is defined between a pair of guide members 24 formed at the rear of the fifth wheel 22.

A pin hole 32 is defined in the plate 22 to the left of and adjacent the pin slot 28, the pin hole 32 being for receipt of a pivot pin 34 therethrough.

A pair of attachment tabs 36 projects down from the underside of opposite sides of the coupling plate 22. Each tab defines a pin hole 38.

The right side of coupling plate 22 also defines a rectangular lever slot 40 towards the front, and a circular plunger hole 42 at the junction of the guide members 24 with the remainder of the plate 22.

The support mechanism 16 of the first roll coupling device 2 comprises a single support arm 44. The support arm 44 comprises a square shaped main shaft 46 with rounded corners, the main shaft branching into a pair of prongs 48 posteriorly. Towards the rear of each prong 48 is defined a pair of pin holes 54 for receipt therethrough of pins 50 in surrounding bushes 52. The pins 50 and bushes 52 also pass further outwardly, through pin holes 50 of respective attachment tabs 36, thereby pivotally connecting the roll coupling member 10 with the support arm 44, the pivotal connection enabling pitching movement of the draw member 12.

The support mechanism 16 further comprises a bar guide having an attachment plate 56 through which passes a sleeve 55 that envelopes the front of the main shaft 46. The main shaft 46 narrows into a cylinder 62 beyond the sleeve 55, the cylinder 62 having a screw thread for fastening of a castle nut 60. The support mechanism further comprises a rubber spring 57 and a tension washer 58.

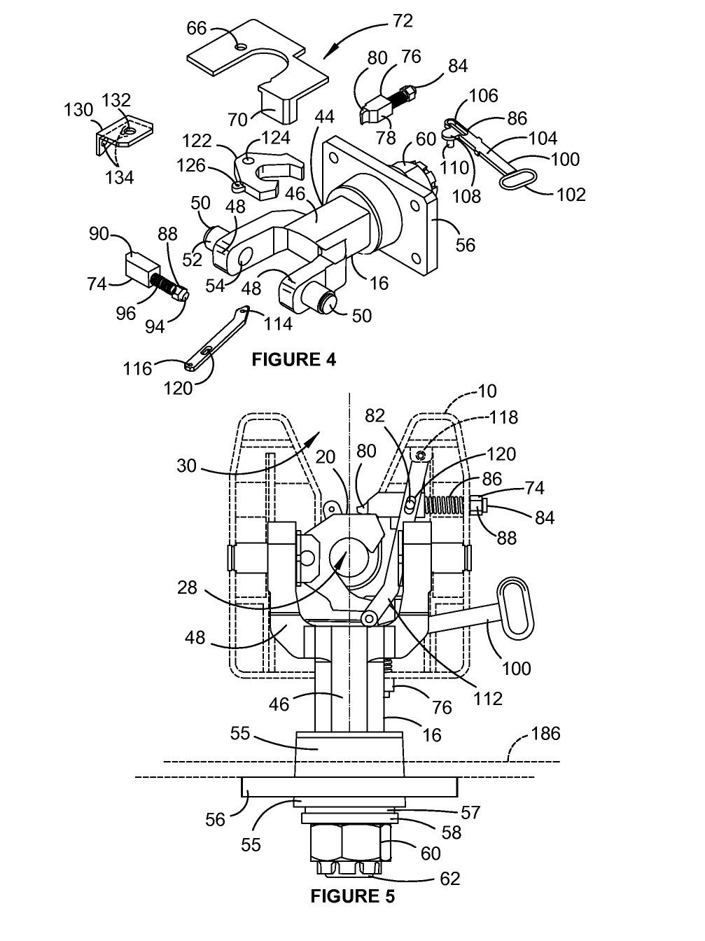

As shown most clearly in FIG. 4, the locking mechanism 20 comprises an intermediate plate 64. The intermediate plate 64 defines a pivot pin hole 66 which is aligned with and beneath pin hole 32 of the coupling plate 22, and a king pin slot 68 which is aligned with and beneath pin slot 28 of the coupling plate 22. A plunger tab 70 projects down vertically from a right rear portion of the intermediate plate 64, and a square plunger recess 72 is defined in the front right corner of the plate.

Beneath the intermediate plate 64, the locking mechanism 20 further comprises a first plunger 74 abutted lengthwise against the rear of plunger tab 70, and a second plunger 76 which projects forward from within the plunger recess 72.

The first plunger 74 has a rectangular shaped housing 78, a cammed portion 80 at the inner end of the rectangular shaped housing 78, a pin 82 projecting from the underside of the housing 78 towards its outer end, a threaded cylindrical shaft 84 projecting outwardly from the outer end of the housing 78, a cylindrical sleeve surrounding the cylindrical shaft 84, a tension spring 86 winding around the cylindrical sleeve, and a hexagonal nut 88 screwed on to the end of the cylindrical shaft 84.

The second plunger 76 has a rectangular shaped housing 90, a pin 92 projecting from the underside of the housing 78 towards its front end, a threaded cylindrical shaft 94 projecting outwardly from the outer end of the housing 90, a cylindrical sleeve surrounding the cylindrical shaft 94, a tension spring 96 winding around the cylindrical sleeve, and a hexagonal nut 98 screwed on to the end of the cylindrical shaft 94.

At the horizontal level of the plungers, the locking mechanism 20 comprises a generally C-shaped lock jaw 122 defining pivot pin hole 124. The pivot pin hole 124 is aligned above with pivot pin hole 66, both being adapted for receipt of pivot pin 34 therethrough. The lock jaw 122 also has a tab 126 with tab hole 128.

Immediately beneath and contacting the lock jaw 122, the locking mechanism 20 comprises an L-shaped bottom plate 130 having a horizontal portion which defines a pivot pin hole 132 for alignment with the pivot pin holes above and receipt of the pivot pin 34 therethrough. The L-shaped bottom plate 130 further has a vertical portion defining a pair of fastener holes for enabling fastening of the bottom plate 130 to the coupling plate 22.

Immediately beneath and contacting the second plunger 76, the locking mechanism 20 comprises a handle lever 100 having a shaft 104, a handle portion 12 at the outer end of the shaft 104, an elongate slot 106 towards its inner end for slidable receipt of plunger pin 92, and a side tab 108 with downwardly projecting pin 110.

Immediately beneath and contacting the handle lever 101 and first plunger 74, the locking mechanism 20 comprises a bent lever 112 defining a pin hole 114 near its front end for receipt of downwardly projecting pin 110, a pin hole 116 near its rear end for receipt of a plate pin 118, thereby enabling the bent lever 112 to be pivotably anchored to the coupling plate 22, and a pin slot 120 for slidable receipt of first plunger pin 82.

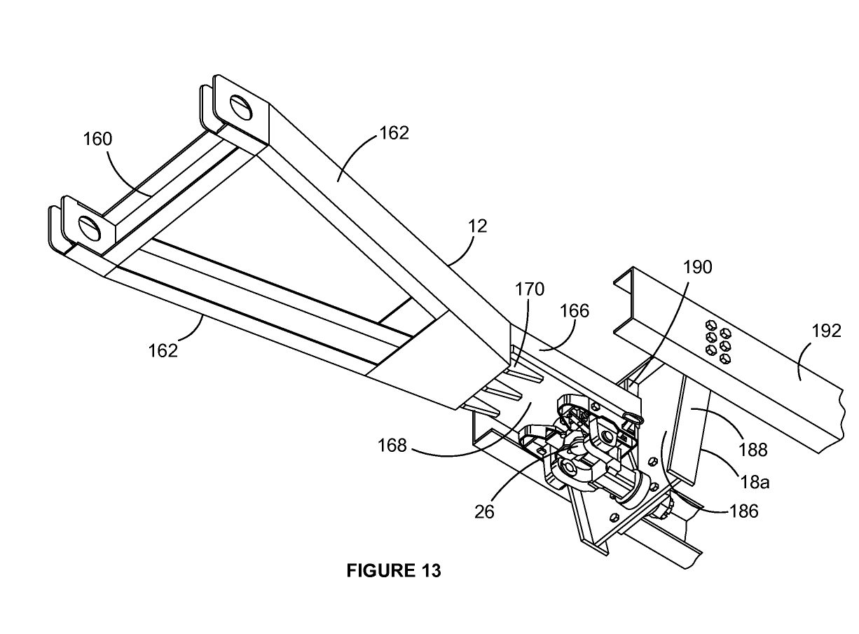

FIGS. 12, 13, 19 and 20 illustrate the first tow member 18a which is suitably designed for attachment of the first roll coupling device 2. The first tow member 18a comprises a generally upright transverse plate 186 which, other than its bottom edge, is surrounded by a perpendicular flange 188 projecting forward and rearward of the plate. A pair of front and rear gussets is located centrally on front and rear surfaces of the plate 186, the gussets 190 extending from the flange 188 at the top of the plate down towards an arm hole which is adapted for receipt of the support arm 44.

Generally vertical side portions of the flange 188 near the top of the upright transverse plate 186 are bolted to right and left chassis beams 192 of the tow vehicle, thereby affixing the tow member 18a with the tow vehicle. It is envisaged that alternative support structures of the vehicle may also be used for attachment of the tow member thereto, or indeed the tow member may form part of the structure of the tow vehicle itself.

The support mechanism 16 is fixed to the tow member 18a by bolting of the attachment plate 56 to the upright transverse plate 186, and screwing of the castle nut 60 on to the threaded cylinder 62.

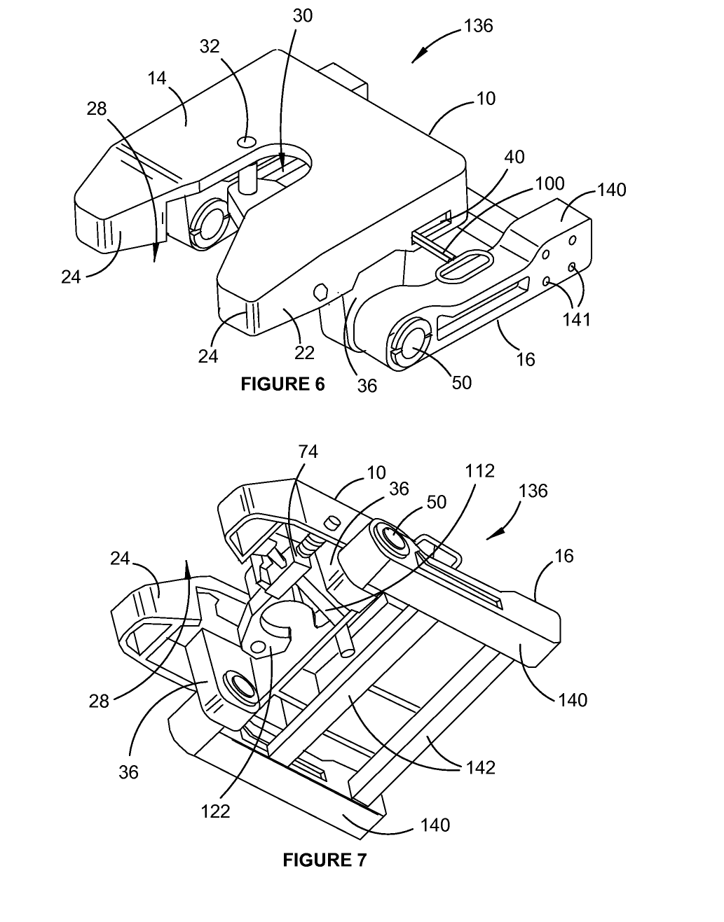

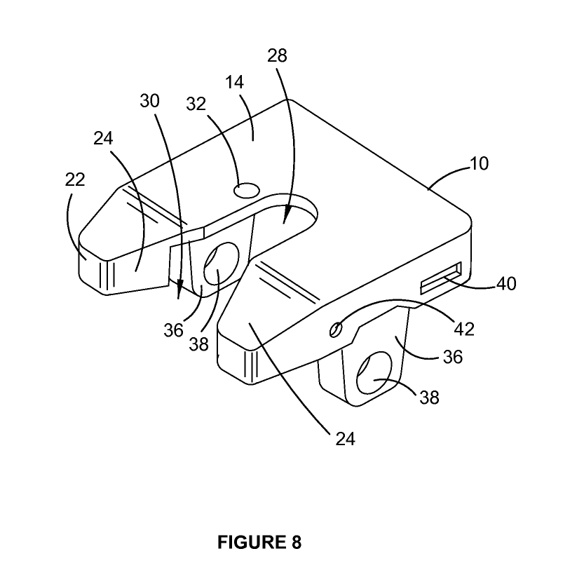

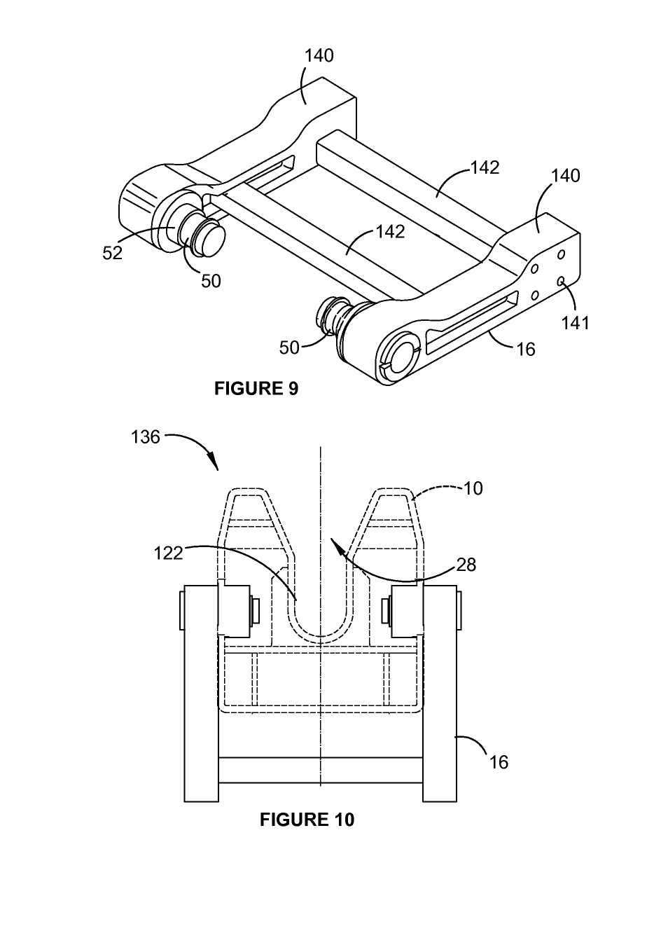

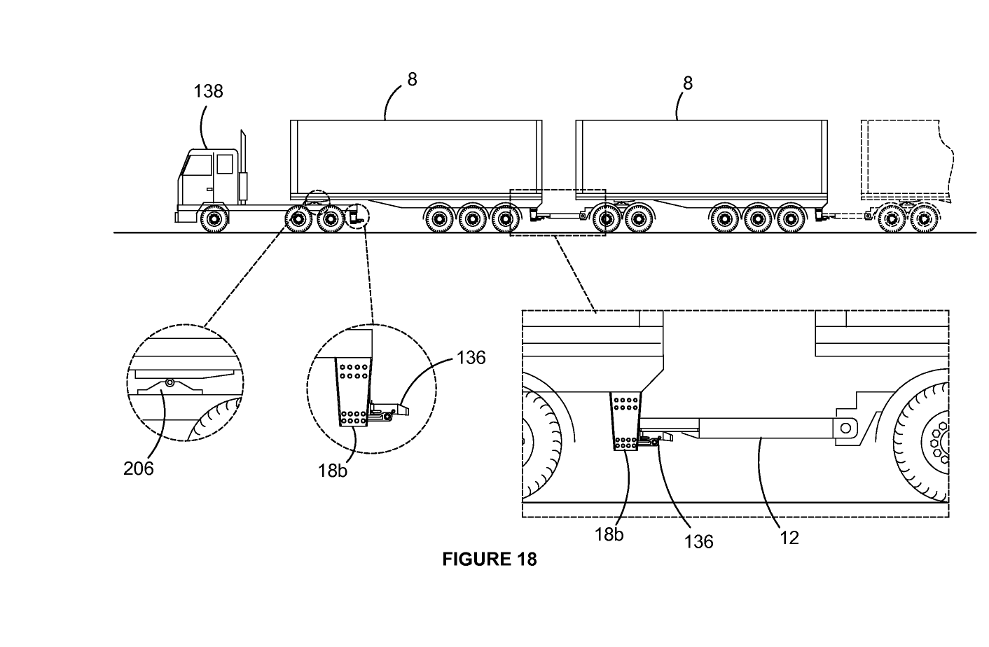

Referring now to FIGS. 6 to 10 there is shown a second roll coupling device, generally designated 136, for linking a tow vehicle (see, for example, prime mover 138 or trailer 8 in FIG. 18) and a drawn vehicle (see, for example, trailer 8 in FIG. 18).

For ease of reference, features of the second roll coupling device which are like features of the first roll coupling device have been identified using the same reference numerals, although differences in size, shape, configuration or function may be evident.

Like the first roll coupling device 2, the second roll coupling device 136 comprises:
a roll coupling member 10 connectable to a draw member 12 (see, for example, FIG. 18), the roll coupling member 10 having a coupling surface 14 adapted for slidable rotation of the draw member 12 thereon, the draw member 12 being attachable to the drawn vehicle 8;
a support mechanism 16 for supporting the roll coupling member, the support mechanism 16 being attachable to a tow member 18 (see, for example, FIG. 18), the tow member 18 being fixed to, or as part of, the tow vehicle, 138 or 8; and
a locking mechanism (not shown) for locking the draw member 12 in connection with the roll coupling member 10.

The locking mechanism of the second roll coupling device may be adapted from that which is described for the first roll coupling device 2, or from other known locking mechanisms used in the industry.

Rather than having a single central support arm, the second roll coupling device 136 differs from the first roll coupling device 2 in that the support mechanism 16 comprises a pair of lateral support arms 140 which pitch pivotally connect with the outer sides of the coupling plate 22 via projection of pins 50 into respective pin holes 38. Towards the front and on the outer side of each support arm 140 there is defined a square array of four bolt holes 141. A pair of cross members 142 extends transversely between the support arms 140.

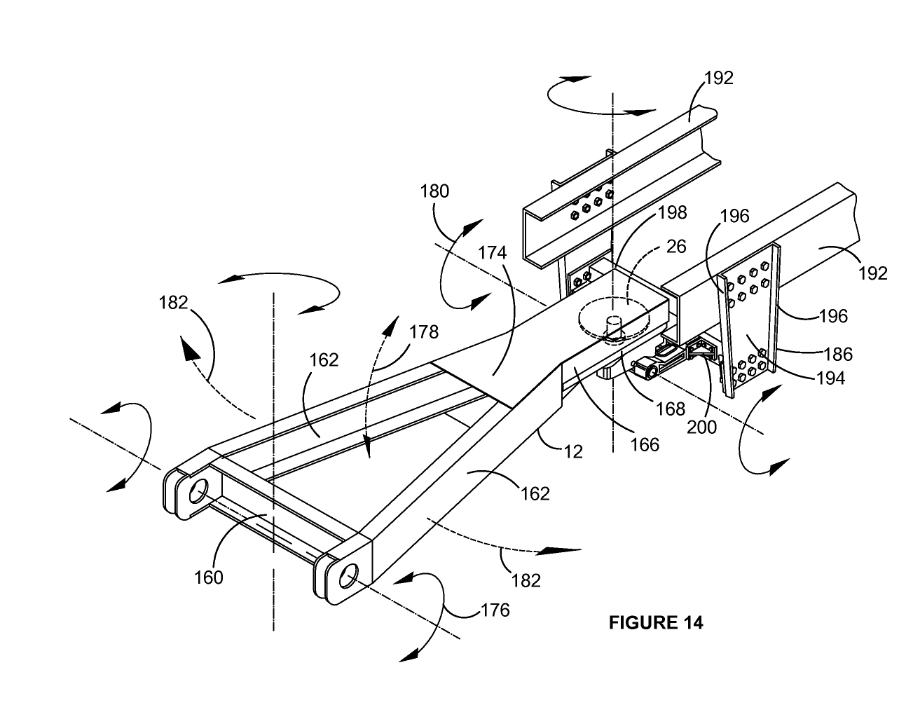

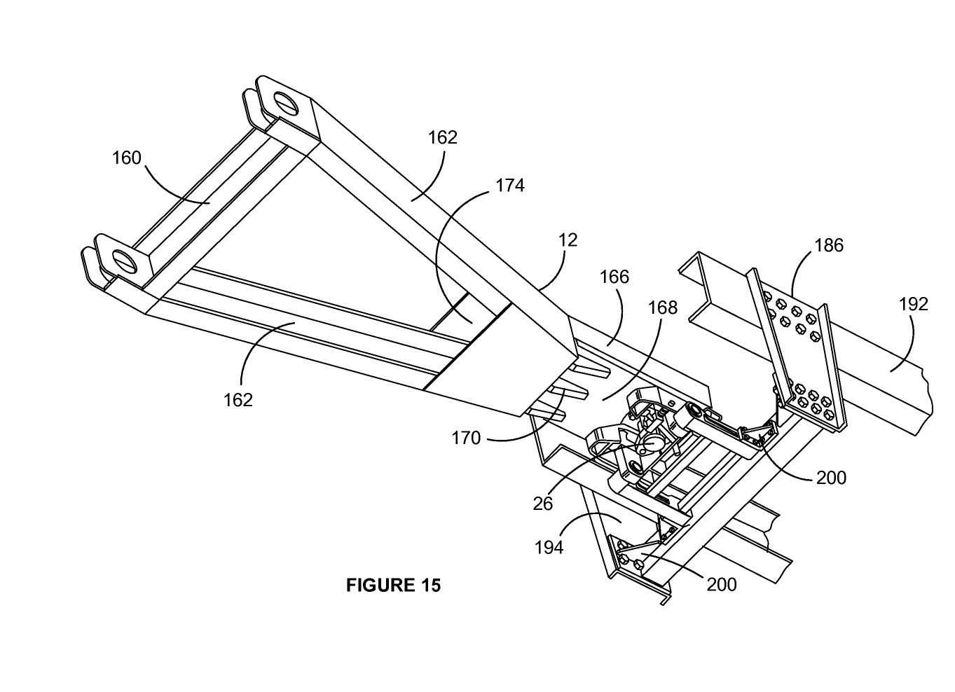

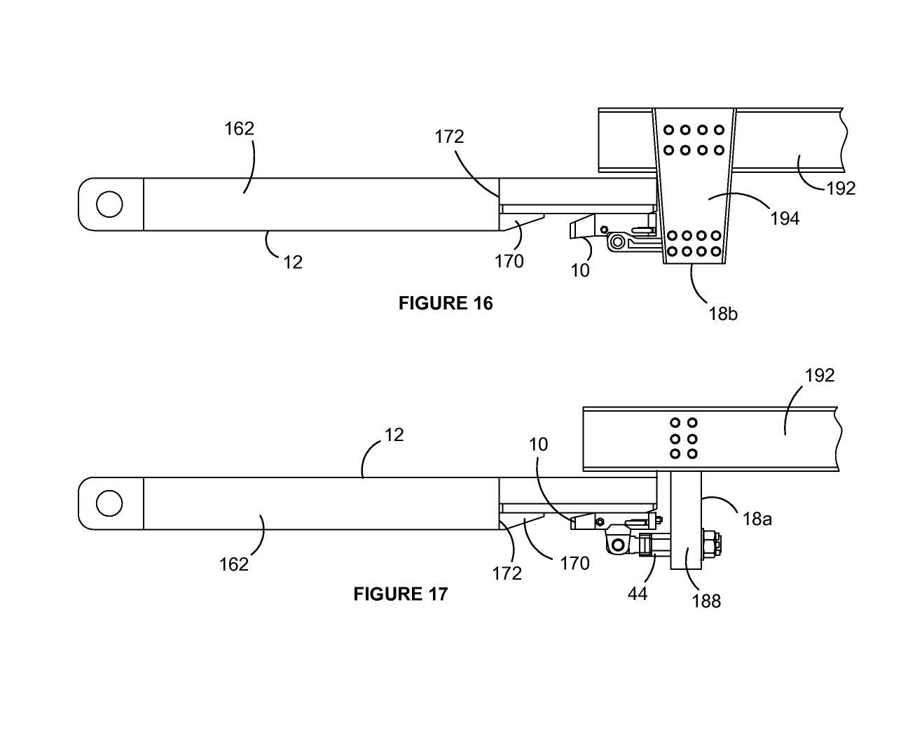

FIGS. 14, 15, 16 and 18 illustrate the second tow member 18b which is suitably designed for attachment of the second roll coupling device 136. The second tow member 18b comprises a generally upright side plate 194 with a pair of front and rear flanges 196 extending outwardly from the front and rear edges of the side plate 194. The upper section of the side plates 194 are bolted to the chassis beams 192 of the tow vehicle.

The second tow member 18b further comprises a crossbar channel 198 having a pair of end flanges which are bolted to adjacent side plates 194.

Left and right L-brackets 200, each with a triangular web, are bolted anteriorly to the rear surface of the crossbar channel 198, and medially to the bolt holes 140 in the lateral surface of respective support arms 140, thereby affixing the support mechanism 16 to the second tow member 18b.

It should be understood that the first roll coupling device 2 may be attached to various types and forms of tow members including the second tow member 18b. Similarly, the second roll coupling device 136 may be attached to various types and forms of tow members including the first tow member 18a.

Referring now to FIGS. 12 to 17 there is shown the draw member 12 as connected with the first roll coupling device 2 in FIGS. 12, 13 and 17, and as connected with the second roll coupling device 136 in FIGS. 14, 15 and 16.

The draw member 12 is optimised for torsion and weight, having a box shaped front portion and a triangularly shaped rear portion.

The triangularly shaped rear portion comprises:
a rear beam 160,
a pair of attachment beams 64 at opposite ends of the rear beam 160, the attachment beams 64 being adapted for a pivotal connection with a drawn vehicle,
a pair of converging beams 162 extending forwards and converging towards each other from the attachment beams 164,
a bottom trapezoidal gusset which extends between and beneath the converging beams towards their front ends, and
a trapezoidal rear portion of a top gusset 174 which covers the converging beams towards their front ends.

The box shaped front portion comprises:
a front gusset 172 in front of and extending between the front ends of the converging beams 16,
a pair of parallel front beams 166 which extend forward from front gusset in line with the front ends of the converging beams 162,
a skid plate 168 extending atop and between the front beams 166, the skid plate being adapted to slide or skid on the coupling surface 14 of the coupling plate 22,
three triangular gussets 170 extending between the base of the skid plate 168 and the front gusset,
a square front portion of the top gusset 174 in front of the rear trapezoidal portion, and
the king pin 26 which has a cylindrical stem and enlarged circular head, the enlarged circular head being bolted to the underside of the skid plate 168, the cylindrical shaft being adapted for receipt in the king pin slots of the locking mechanism 20.

Each of the beams is C-shaped with a depth approximately three times that of its width. However, it is envisaged that other shaped beams may be used including rectangular shaped beams and I-beams.

As shown in FIGS. 12 and 14, the connection between the attachment beams 164 and the drawn vehicle allows forward and backward rotational movement, as indicated by arrow 176, about a transverse and generally horizontal axis. This pivotal movement enables upward and downward pitching movement of the front end of the draw member as indicated by arrow 178.

Upward and downward pitching movement of the rear end of the draw member, as also indicated by arrow 178, is enabled by the pivotal connection between the roll coupling member 10 and the support mechanism 16. The pivotal connection allows forward and backward rotation, as indicated by arrows 180, about a transverse and generally horizontal axis.

The pivotal connection formed when the king pin 26 is locked in the king pin slots of the roll coupling member 10 allows right and left rotational movement, as indicated by arrow 182, around a generally vertical axis. This freedom to pivot translates to curved rightward and leftward movement, as indicated by arrows 182, of the rear end of the draw member.

Referring now to FIGS. 11A to F, there is shown a sequence of views illustrating the process of connection and disconnection of the draw member 12 via locking and unlocking of the locking mechanism 20.

In FIG. 11A the locking mechanism 20 is in a locked configuration, with the stem of the king pin 26 locked in the king pin slots by closed lock jaw 122. The lock jaw 122 is prevented from opening by its abutment against the first plunger 74, which itself is locked in a protracted position due to locking of the handle lever 100 in a rear protracted position. The handle lever 100 is locked in a closed position due to catching of its rear catch 202 on a corresponding part of the coupling plate 22.

A user is able to unlock the locking mechanism 20 by pulling handle lever 100 out (i.e. into retraction) and forward. As illustrated in FIG. 11B, such movement of the handle lever 100 causes disengagement of the rear catch 202 from the coupling plate 22, concomitant outward pivoting of bent lever 112, retraction of the second plunger 76, and retraction of the first plunger 74. The lever handle is locked in an open position by catching of a front catch 204 on a corresponding portion of the coupling plate 22.

Although no longer locked in position by the first plunger 74, the lock jaw 122 remains in the closed position until such time as the tow vehicle, with the first roll coupling device firmly affixed thereto, is driven forward from the stationary drawbar and king pin. As illustrated in FIGS. 11C to 11F, this leads to relative rearward displacement of the king pin 26 with respect to the coupling plate 22, such that the stem of the king pin 26 urges back against the rear jaw portion of lock jaw 122, causing the lock jaw to pivot open. In FIG. 11E the stem of the king pin can be seen forcing its way past the cammed portion 80 of the first plunger 74 as it moves out of the grasp of lock jaw 122.

In order to connect the draw member with the roll coupling device the reverse process occurs whereby the tow vehicle is reversed towards the stationary draw member and king pin 26. The stem of the king pin 26 is guided by guide members 24 into the king pin slots as the tow vehicle is reversed. As this happens the stem of the king pin 26 pushes past the cammed portion of the first plunger, and the front portion of the lock jaw is urged forward so that the lock jaw closes around the stem.

The user then unlocks the handle lever 100 from the open position by pushing the handle lever inward and rearward. This movement causes disengagement of the front catch 204, as well as concomitant inward pivoting of the bent lever 112 and protraction of the first and second plungers. The lever handle is again locked in the closed position by catching of the rear catch 202 on the corresponding portion of the coupling plate 22.

FIGS. 21 to 43 show an improved roll coupling system, generally designated 208i.

For ease of reference, features of the roll coupling system 208i which are like features for previously mentioned embodiments of the invention have been identified using the same reference numerals followed by an T, although differences in size, shape, configuration or function may be evident.

With reference to FIG. 21, the roll coupling system 208i comprises:
a draw member 12i attachable to the drawn vehicle;
a tow member 18i adapted to fixedly hang from the chassis of the tow vehicle towards the rear end thereof; and
a roll coupling device 2i interconnecting the draw member 12i and the tow member 18i.

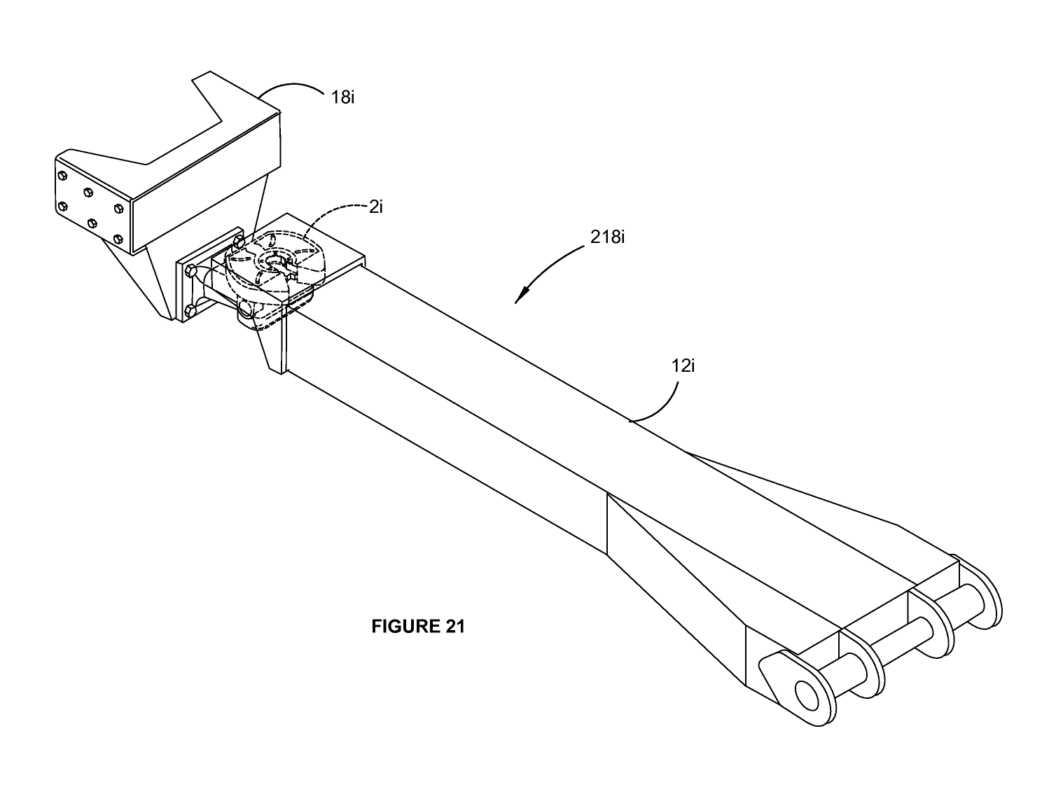

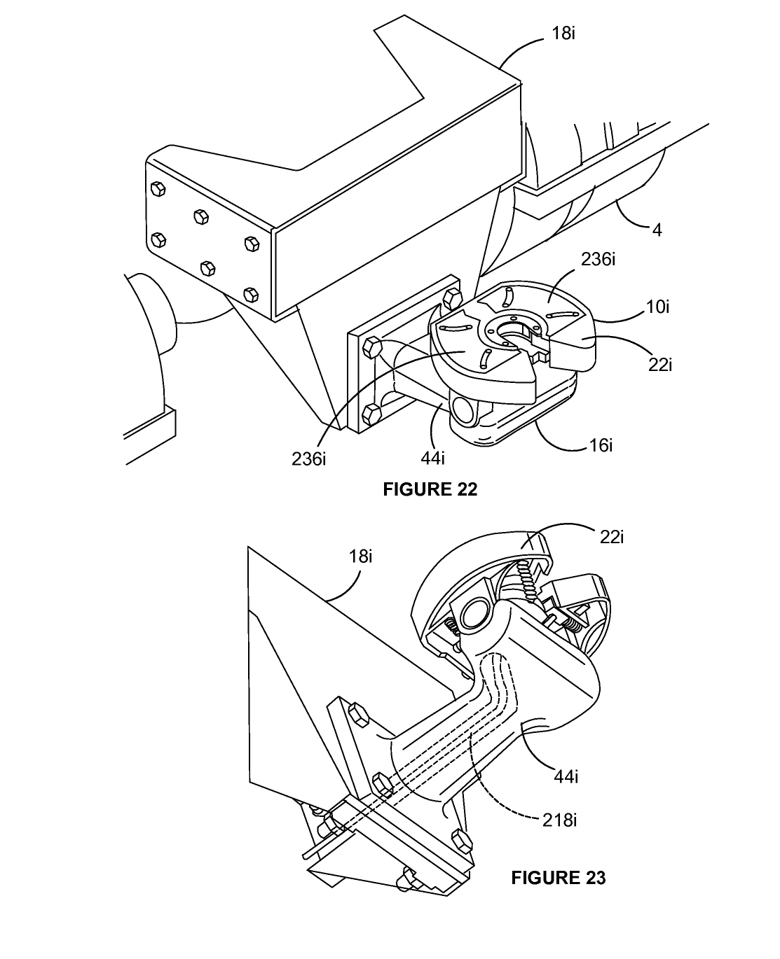

As shown in FIGS. 22 and 23, a compact fifth wheel 22i is mounted on the tow member 18i by virtue of support arm 44i. The tow member 18i forms the rear overhang of a truck 4 (see FIG. 22).

In comparison to aforementioned embodiments of the invention, roll coupling system 201i comprises various additional, different, and/or modified features, as shown in the drawings, and some of which are discussed below.

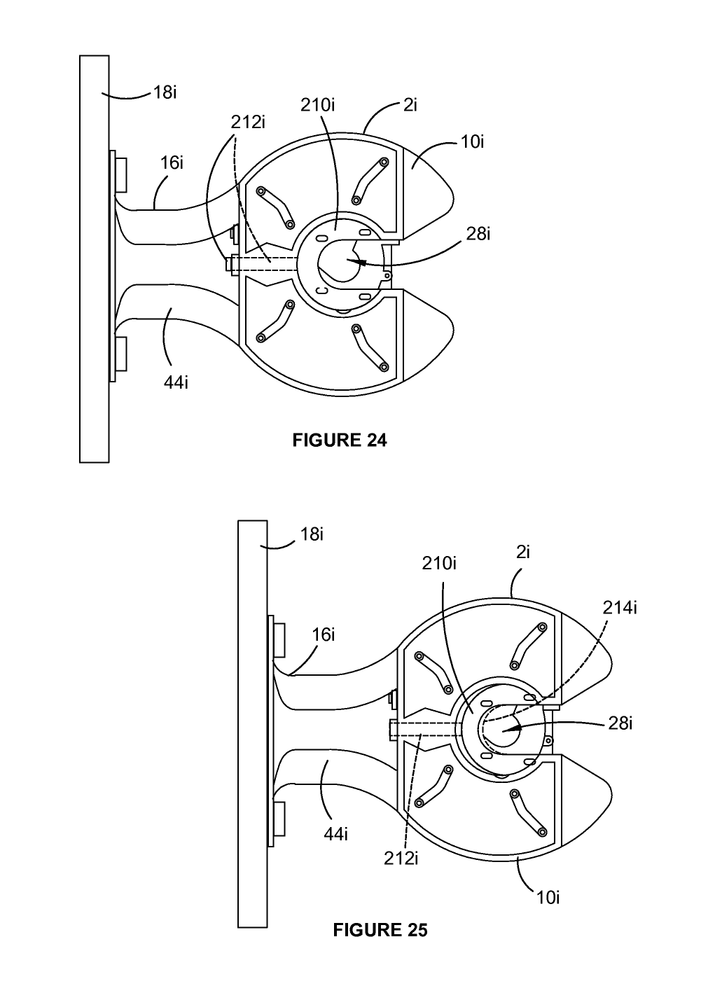

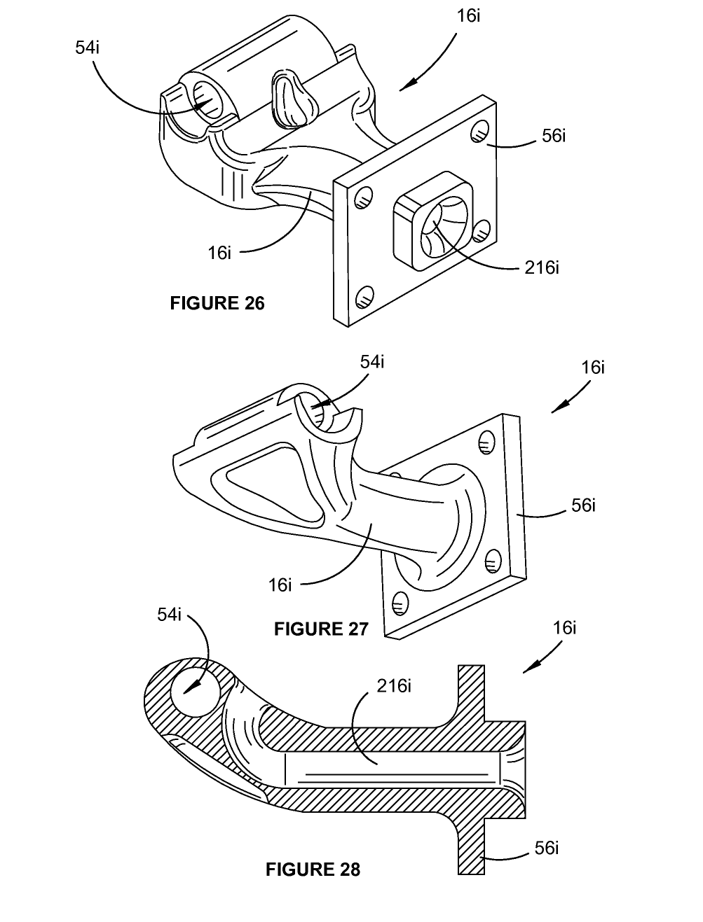

Referring now to FIGS. 24 and 25, there is shown a top plan sequence of views of the roll coupling device 2i fixed to the tow member 18i. Mounted atop the fifth wheel or roll coupling member 10i of the roll coupling device 2i, is an adjustable wearing ring 210i, which wearing ring defines a perimeter boundary for the pin slot 28i. The adjustable wearing ring 210i is a replaceable part which is designed to wear due to friction with the king pin 26i of the draw member 12i (FIG. 26i), thereby reducing wear of the king pin and pin slot. The inclusion of the adjustable wearing ring may be particularly advantageous in this embodiment due to greater frictional and load bearing demands placed on the joint between the king pin 26i and pin slot 28i resulting from the use of a dual system for transferring roll moment 296i (FIG. 33), as described further below.

In FIG. 24 the wearing ring 210i is shown in an unworn state. An adjustable bolt 212i is shown fully retracted so that the wearing ring is able to rest as far forward on the fifth wheel as possible. FIG. 25 then shows the wearing ring 210i after it has been worn due to friction with the king pin 26i. In the region of wearing, the original unworn boundary of the wearing ring 210i is shown in dashed line and referenced by numeral 214i.

Once slop occurs between the wearing ring 210i and king pin 26i, due to wearing of the ring 210i, a user is able to loosen screws (not shown) in the fifth wheel so as to free the adjustable bolt 212i. The user then protracts the adjustable bolt, thereby urging forward the wearing ring, and removing slop from its articulation with the king pin, before retightening the screws so that the adjustable bolt is held in the protracted position. Eventually, with further wearing and slop again increasing in the articulation between the wearing ring and the king pin, the ring will need to be replaced.

A pair of upper friction inserts 236i are also shown present on the top surface of the fifth wheel for reducing friction on sliding of the skid plate thereon.

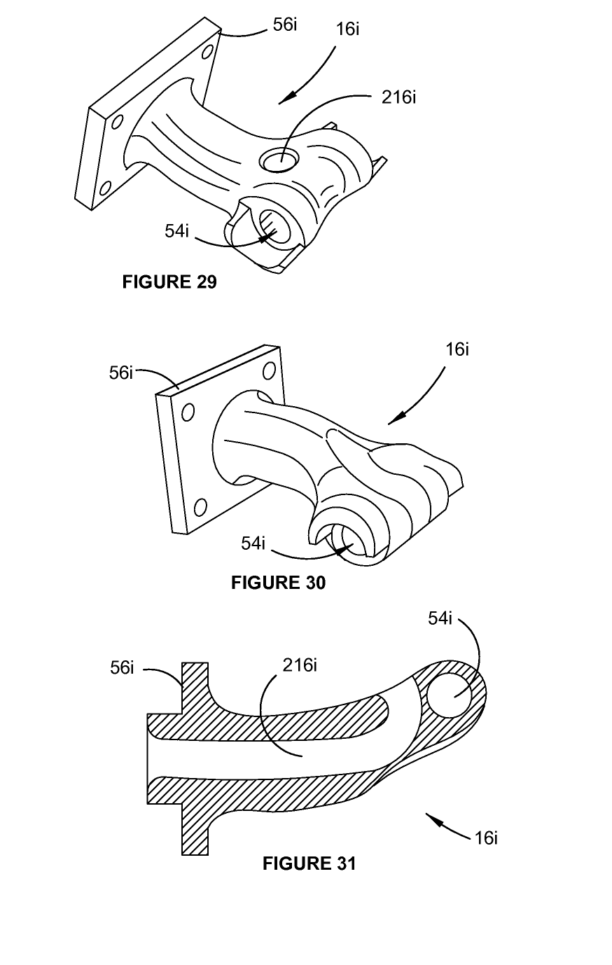

Referring now to FIGS. 26 to 31, there is shown first (FIG. 26), second (FIGS. 27 and 28), and third (FIGS. 29 to 31) improved support mechanisms 16i for a roll coupling device 2i. Each of the support mechanisms 16i comprises a single support arm 44i which widens towards its rear where it defines an elongate tubular pin hole 54i for pivotal connection to the roll coupling member 10i.

The shaft of the support arm 44i defines a J-shaped line passage 216i used for the confined and protected passage of air lines 218i (see FIG. 23) to the locking mechanism 20i. The line passage 216i extends back centrally through the support arm 44i from its front end, before curving upwardly as the support arm broadens in front of the pin hole 54i, and exits externally from the top surface of the support arm towards its rear end.

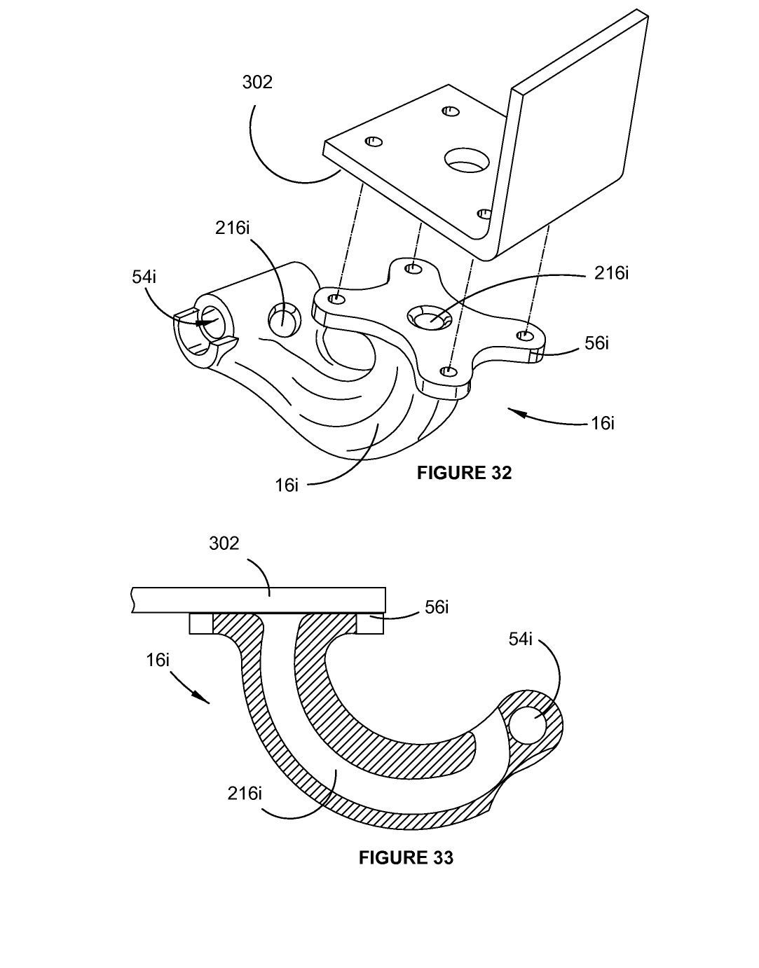

Referring to FIGS. 32 and 33, there is shown a fourth improved support mechanism 16i for a roll coupling device 2i. The fourth improved support mechanism 16i differs from the previously mentioned support mechanisms in that it is attachable to the undersurface of a horizontal plate or bracket 302 of a tow vehicle or tow member attachable towards the rear of the tow vehicle.

It is envisaged that further forms of support mechanisms utilising support arms may also be produced that are adapted for attachment to straight portions of plates or surfaces of the tow vehicle or tow member having any orientation. Thus, the support mechanism may be mounted on either side of a vertical surface or plate, or mounted on top of or to the underside of a horizontal surface or plate, or mounted on a surface or plate angled in any direction between vertical and horizontal.

Further, it is envisaged that the attachment plate 56i of the support mechanism may be L-shaped for attachment to a corner of the tow member or vehicle, or C-shaped for surrounding attachment to an end of a horizontal plate or platform of the tow member or vehicle.

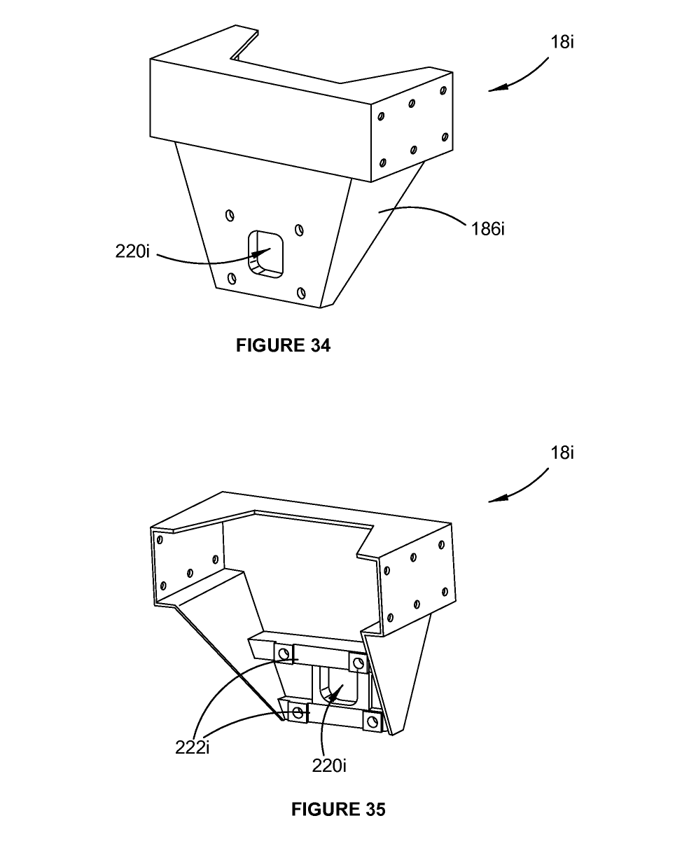

Referring now to FIGS. 34 and 35, there is shown the tow member or bracket 18i which is of modular design, and fixable to the rear chassis of a vehicle 4, thereby forming a rear overhang. The rear overhang has a substantially vertical or upright plate 186i designed for attachment of the support arm 44i. In particular, the upright plate has a square recess 220i with rounded corners for fitted passage of the like-shaped shaft of the support arm 16i. The upright plate 186i further includes a pair of horizontal or transverse roll stiffeners 222i for enhancing roll strength at the bolting site of the support arm's attachment plate 56i.

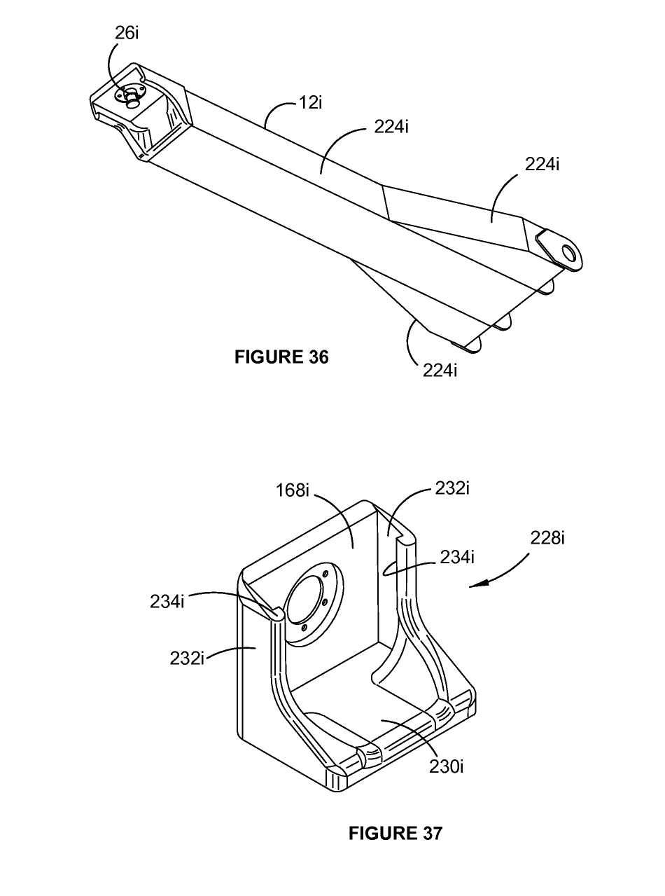

Referring now to FIG. 36, there is shown the draw bar or member 12i which, unlike conventional draw bars, is designed to transfer roll moment to the vehicle being towed. The draw bar is of modular design utilising prefabricated and pre-welded rectangular hollow sections 224i which provide for a relatively lightweight rigid frame. A user may reduce the length of the draw bar by cutting shorter the length of the central rectangular hollow section, and reattaching the side sections so that they end with the central section. Alternatively, for longer tow bars where longer central and side sections are utilised, the length of the draw bar may be reduced by cutting shorter the length of all three rectangular hollow sections and reattaching end brackets 226i on to the newly formed end. The front end of the draw bar 12i further includes a wrap-around skid plate assembly 228i with king pin 26i.

FIG. 37 shows the wrap-around skid plate assembly 228i in more detail. It comprises a skid plate 168i, a rear wall 230i extending downwardly from the rear of the skid plate 168i, and clamping side walls 232i extending downwardly from the sides of the skid plate 168 and forwardly from the rear wall 230i, the clamping side walls 232i each having an internal ridge 234i. The arrangement is such that, when the pin slot 26i of the fifth wheel is moved into articulation with the king pin 26i of the draw bar, the skid plate rests atop the fifth wheel and the clamping side walls wrap around and beneath its sides, thereby clamping and coupling the fifth wheel for rolling movements.

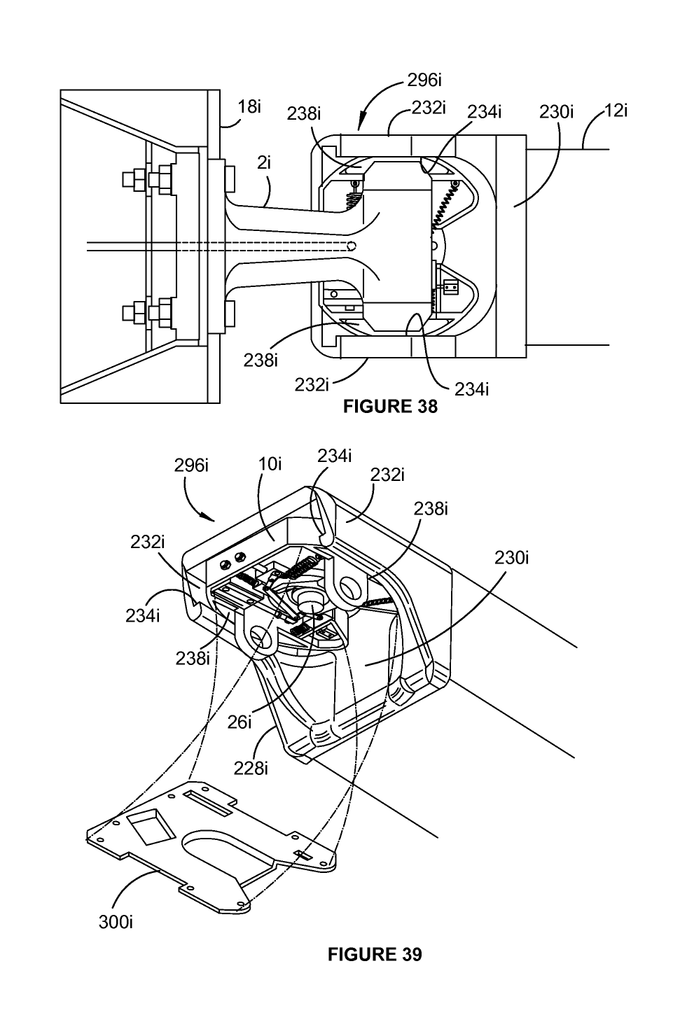

Referring now to FIGS. 38 and 39, the roll coupling device 2 is shown engaged with the draw member 12i so that the king pin 26i is locked within the pin slot 28i, and the fifth wheel 10i is clamped within the wrap-around skid plate assembly 228i, bearing weight from the skid plate 168i above and grasped on opposite sides from beneath by the internal ridges 234i. Thus, a dual system of transferring roll moment 296i is created, whereby firstly, as in prior art fifth wheels, high downward vertical contact pressure is imparted from above by the skid plate in order to provide a roll coupling, and secondly, unique to the present design, the wrap-around arrangement or system provides enhanced dynamic stability and enables roll moment to be imparted on the underside of the fifth-wheel.

A pair of lower low friction inserts 238i are provided on the undersurface of the fifth wheel towards the sides thereof, thereby reducing friction and wear between the internal ridges 234i and undersurface of the fifth wheel on rolling and sliding of the draw bar.

As the king pin 26i and lock jaw 122i connection are also involved in the secondary roll moment coupling, the lock jaw 122i has a recessed portion 240i in its lower inner boundary so as increase the surface area over which pressure from the king pin can be spread. Similarly, the engagement surface of the fifth wheel defining the pin slot 26i has a recessed portion 298i in its lower inner boundary so as increase the surface area over which pressure from the king pin can be spread.

The wrap-around skid plate system is designed to constrain movement and support coupling loads in torsional (roll coupled), vertical (up/down) and longitudinal (for-aft) directions.

The unique wrap-around method of transferring roll moment can be particularly important for enhancing dynamic stability during an avoidance manoeuvre. Further, the arrangement may reduce downward vertical loads placed upon the fifth wheel in use, and enables the safe and effective use of a smaller diameter fifth wheel than those conventionally used. The ability to use a smaller and lighter fifth wheel than the extremely bulky and heavy designs presently available is of great advantage to the present fifth wheel market, and opens up a new market for fifth-wheel usage with less-heavy vehicles.

Also shown exploded in FIG. 39 is a dust cover 300i for the locking mechanism.

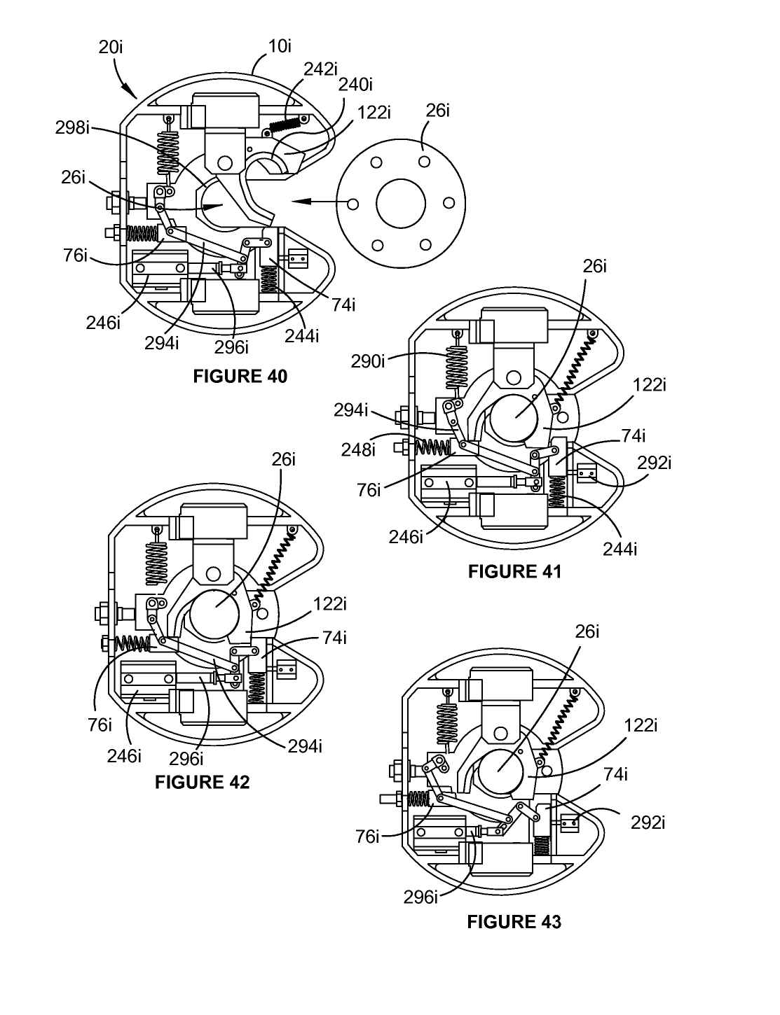

FIGS. 40 to 43 show a locking sequence for the locking mechanism 20i present at the underside of the fifth wheel 10i. In FIG. 40, the locking mechanism is shown in an unlocked and open configuration waiting for a trailer, wherein:
the crescent shaped lock jaw 122i is in an open position with its semicircular recess facing forwards for receipt of the incoming king pin 26i;
a jaw spring 242i is in a shortened state, holding open the lock jaw 122i;
a primary plunger 74i with compression spring 244i is in a compressed position, blocked from extending by abutment with an end of the lock jaw 240i; and
a primary or main pneumatic actuator 246i receives air lines 218i (see FIG. 23) from park brakes (not shown), so that when the park brakes are on (as is the case here), the primary actuator 246i is inactive.

In FIG. 41, the locking mechanism is in a passively engaged and locked configuration, wherein:
the king pin 26i has been moved into the pin slot 26i by virtue of the truck reversing;
primary and secondary plungers, 74i and 76i respectively, are urged into extended positions by their respective compression springs, 244i and 248i, and by shortening of a main tension spring 290i attached to lever member 294i, the various components of which connect with the primary and secondary plungers (and the primary pneumatic actuator);
a secondary lock or small pneumatic actuator 292i automatically projects into a hole in the side of the primary plunger 74i as it moves into the extended position, thereby secondarily locking the primary plunger into the extended position (as a back-up in case of failure of the main pneumatic actuator 246i once activated);
although bar 296i of primary pneumatic actuator 246i is extended further from housing by virtue of its attachment to interconnecting components of the lever member 294i, the primary pneumatic actuator 246i remains passive/unactivated;

In FIG. 42, the locking mechanism is in an actively engaged and locked configuration, wherein:
park brakes are disengaged, thereby activating the primary pneumatic actuator, such that a protraction or extension force is applied to the already fully protracted bar, thereby applying pressure via the lever member 294i to hold and maintain primary and secondary plungers, 74i and 76i, in their extended positions, thus securely locking the closed jaw around the king pin.

In FIG. 43, the locking mechanism is in an unlocked configuration, ready for decoupling, wherein:
the secondary lock is unlocked by the pneumatic actuator rod being retracted from a hole in the primary plunger 74i; and
park brakes are on (park brake interlock), causing retraction of the main actuator bar 269i, which in turn forces retraction of the primary and secondary plungers, 74i and 76i respectively, thereby unlocking lock jaw 122i so that the king pin 26i may be disengaged from the pin slot and lock jaw by forward driving of the truck.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the broad consistory statements. Various modifications and equivalent arrangements are intended to be included within the spirit and scope of the invention and consistory statements herein. Therefore, the specific embodiments are to be understood to be illustrative of the many ways in which the principles of the present invention may be practiced.

Where the terms “comprise”, “comprises”, “comprised” or “comprising” are used in this specification, they are to be interpreted as specifying the presence of the stated features, integers, steps or components referred to, but not to preclude the presence or addition of one or more other features, integers, steps, components to be grouped therewith.

1. A roll coupling device for linking a tow vehicle and a drawn vehicle, the device comprising:
a roll coupling member for coupling with a wrap-around skid assembly of a draw member, the draw member being directly or indirectly connectable to or formed with the drawn vehicle, the roll coupling member having upwardly and downwardly facing coupling surfaces adapted for slidable engagement with the wrap-around skid assembly;
a locking mechanism for locking the roll coupling member in connection with the draw member; and
a support mechanism for mounting the roll coupling member on a tow member attachable to or formed with the tow vehicle.

2. The roll coupling device according to claim 1 wherein the support mechanism is adapted for attachment to a rearward or downward facing surface of the tow member.

3. The roll coupling device according to claim 1 or claim 2 wherein the support mechanism is pivotally attached to the roll coupling member so as to enable pitching movement of the draw member.

4. The roll coupling device according to any one of the preceding claims wherein the coupling member comprises a fifth wheel defining a central pin hole and having rear guide portions for guiding a pin of the draw member into the pin hole.

5. The roll coupling device according to any one of claims 1 to 3 wherein the locking mechanism comprises an enclosing member adapted to swivel around and enclose a pin of the draw member as it is moved into a pin hole of the roll coupling member, the locking mechanism being adapted for locking the enclosing member when the pin is enclosed in the pin hole.

6. The roll coupling device according to any one of the preceding claims wherein the locking mechanism comprises a pneumatic actuator for causing or maintaining locking of the roll coupling member in connection with the draw member, the pneumatic actuator being linked by air line to a park brake of the tow vehicle so that unlocking can only occur when the park brake is engaged.

7. The roll coupling device according to any one of the preceding claims wherein the support mechanism comprises a support arm member pivotally attached to the coupling member thereby enabling upward and downward rotation of the coupling member with respect to the support arm member, the support arm member being adapted for attachment to the tow member.

8. The roll coupling device according to any one of the preceding claims wherein the roll coupling member comprises one or more frictionless inserts that include at least one of the upwardly and downwardly facing coupling surfaces.

9. The roll coupling device according to any one of the preceding claims, wherein the roll coupling member comprises an adjustable and replaceable wearing ring.

10. A draw member for interconnecting a fifth wheel and a drawn vehicle, the draw member comprising a wrap-around skid assembly adapted to wrap over, around a side of, and under a portion of the fifth wheel, thereby slidably engaging upwardly and downwardly facing coupling surfaces of the fifth wheel.

11. The draw member according to claim 10, wherein the wrap-around skid assembly comprises:
a skid plate for sliding upon the upwardly facing coupling surface of the fifth wheel;
a pair of side walls extending downwardly from near the sides of the skid plate; and
a pair of internal flanges extending inwardly from respective side walls, the internal flanges each having an upwardly facing coupling surface for slidable engagement with the downwardly facing coupling surface of the fifth wheel.

12. A tow member for interconnecting a fifth wheel and a tow vehicle, the tow member comprising:
an upright plate member comprising,
an aperture for fitted passage of a support arm of a roll coupling device,
fastening means for fastening a flange of the support arm once the support arm is fitted in the passage,
one or more transverse roll stiffeners for strengthening the site of fastening with the flange of the support arm; and
attachment means for attachment of the upright plate to the rear chassis of a tow vehicle.

13. A roll coupling system for linking a tow vehicle and a drawn vehicle, the system comprising:
a roll coupling device comprising,
a roll coupling member for coupling with a draw member, the roll coupling member having upwardly and downwardly facing coupling surfaces adapted for slidable engagement therewith;
a locking mechanism for locking the roll coupling member in connection with the draw member; and
a support mechanism for mounting the roll coupling member on a tow member of the tow vehicle; and
the draw member comprising,
a wrap-around skid assembly adapted to wrap over, around a side of, and under a portion of the roll coupling member, thereby slidably engaging the upwardly and downwardly facing coupling surfaces of the roll coupling member.
